(19) United States
(12) Patent Application Publication
(10) Pub. No.: US 2026/0355719 A1
(43) Pub. Date: Nov. 12, 2026

(54) LAYERED CATALYSTS FOR PURIFYING EXHAUST GAS STREAMS AND METHODS OF MAKING THE SAME

(71) Applicants: GM GLOBAL TECHNOLOGY OPERATIONS LLC, Detroit, MI (US); BASF Corporation, Mount Olive, NJ (US)

(72) Inventors: Yuntao GU, Bolingbrook, IL (US); Michelle H. WIEBENGA, Farmington Hills, MI (US); Raneen TAHA, Sterling Heights, MI (US); Yuejin LI, Edison, NJ (US); Xiaolai ZHENG, Princeton Junction, NJ (US)

(21) Appl. No.: 19/741,523

(22) Filed: Jul. 14, 2026

Related U.S. Application Data
(62) Division of application No. 18/103,053, filed on Jan. 30, 2023.

(51) Int. Cl. B01J 23/63; B01D 53/94; B01J 21/04; B01J 23/10; B01J 35/00; B01J 35/23; B01J 35/56; B01J 37/02; B01J 37/08; F01N 3/10; F01N 3/28

(52) U.S. Cl. CPC B01J 23/63; B01D 53/945; B01J 21/04; B01J 23/10; B01J 35/19; B01J 35/23; B01J 35/56; B01J 37/0211; B01J 37/0236; B01J 37/024; B01J 37/08; F01N 3/101; F01N 3/2803; B01D 2255/1025; B01D 2255/9155; B01D 2257/404; B01D 2257/502; B01D 2257/702; B01D 2258/01; F01N 2370/02

(57) ABSTRACT

A layered catalyst for purifying an exhaust gas stream includes an alumina substrate, a ceria nanoparticle layer extending over the alumina substrate, and a rhodium catalyst layer comprising an atomic dispersion of rhodium adsorbed on the ceria nanoparticle layer. In an exhaust gas treatment device, the layered catalyst is deposited on wall surfaces of a monolithic substrate. A method for removing hydrocarbon, carbon monoxide, and nitrogen oxides from an exhaust gas stream of a gasoline-powered internal combustion engine includes passing the exhaust gas stream over the layered catalyst.

### CROSS-REFERENCE TO RELATED APPLICATIONS

This application is a divisional of U.S. patent application Ser. No. 18/103,053 filed on Jan. 30, 2023. The entire disclosure of the application referenced above is incorporated herein by reference.

### GOVERNMENT FUNDING

This invention was made with Government support under Agreement No. DE EE0009196 awarded by the U.S. Department of Energy. The Government may have certain rights in the invention.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to catalysts for purifying exhaust gas streams from combustion processes and to methods of manufacturing layered catalyst structures including mixed metal oxide support materials loaded with platinum group metal (PGM) elements (e.g., platinum, rhodium, palladium, et al.) as catalysts.

Exhaust gases from combustion processes typically contain a variety of combustion reaction by-products, including unburned hydrocarbons (HC), carbon monoxide (CO), nitric oxide (NO), and nitrogen dioxide (NO₂), with NO and NO₂ collectively referred to as nitrogen oxides or NOₓ. It may be desirable to reduce or control the emission of HC, CO, and/or NOₓ from various combustion processes into the ambient environment.

Exhaust gas treatment systems for internal combustion engines of automotive vehicles may include a so-called three-way catalyst (TWC) disposed in a path of an exhaust gas stream from the engine, which is designed to simultaneously convert HC, CO, and NOₓ in the exhaust gas stream to CO₂, N₂, and H₂O prior to discharge. Such three-way catalysts oftentimes include one or more platinum group metal elements supported on a thermally and mechanically stable, high surface area porous support material, which may comprise alumina (Al₂O₃) and ceria (CeO₂).

### SUMMARY

A method of manufacturing a layered catalyst for purifying an exhaust gas stream comprises multiple steps. In step (a), a mixture of colloidal ceria, alumina particles, and a liquid medium is introduced into a drying chamber via an atomizer to form atomized droplets of the mixture. In step (b), a drying gas is introduced into the drying chamber such that the atomized droplets contact the drying gas, the liquid medium is removed from the atomized droplets by evaporation, and ceria nanoparticles deposit on surfaces of the alumina particles to form composite catalyst support particles. In step (c), a catalyst precursor comprising a rhodium precursor and colloidal ceria is applied to the composite catalyst support particles. In step (d), the composite catalyst support particles and the catalyst precursor are heated to form the layered catalyst. The layered catalyst comprises an alumina substrate, a ceria nanoparticle layer extending substantially continuously over the alumina substrate, and a rhodium catalyst layer comprising an atomic dispersion of rhodium adsorbed on the ceria nanoparticle layer.

The rhodium catalyst layer may constitute, by weight, greater than or equal to about 0.05% to less than or equal to about 0.3% of the layered catalyst.

The composite catalyst support particles may comprise, by weight, greater than or equal to about 1% to less than or equal to about 10% ceria and greater than or equal to about 90% to less than or equal to about 99% alumina.

The layered catalyst may comprise, by weight, greater than or equal to about 5% to less than or equal to about 15% ceria and greater than or equal to about 85% to less than or equal to about 95% alumina.

The colloidal ceria in the mixture of step (a) may comprise ceria nanoparticles having a D50 diameter of greater than or equal to about 5 nanometers to less than or equal to about 20 nanometers. A weight ratio of the alumina particles to the ceria nanoparticles in the mixture of step (a) may be greater than or equal to about 12.5:1 to less than or equal to about 50:1.

The liquid medium may comprise water.

The drying gas may comprise air and may be introduced into the drying chamber at a temperature of greater than or equal to about 100 degrees Celsius to less than or equal to about 250 degrees Celsius.

The alumina particles may be jet milled to achieve a desired particle size distribution. The jet-milled alumina particles may have a D90 particle diameter of greater than or equal to about 5 micrometers to less than or equal to about 9 micrometers.

The composite catalyst support particles may have a D90 particle diameter of greater than or equal to about 6 micrometers to less than or equal to about 10 micrometers.

After formation of the composite catalyst support particles in step (b), the composite catalyst support particles may not be milled, ground, or otherwise treated to reduce the particle size thereof.

In step (c), the composite catalyst support particles may be impregnated with the catalyst precursor using an incipient wetness impregnation technique.

The composite catalyst support particles and the catalyst precursor may be heated in step (d) at a temperature of greater than or equal to about 350 degrees Celsius to less than or equal to about 800 degrees Celsius.

The mixture of step (a) may be substantially free of a binder.

The rhodium precursor may comprise rhodium nitrate, a rhodium amine complex, a rhodium hydrate complex, or a combination thereof. Heating the composite catalyst support particles and the catalyst precursor in step (d) may release gases or vapors of nitrogen, nitrogen oxides, ammonia, and/or water. The catalyst precursor may have a pH of greater than or equal to about 5 to less than or equal to about 12.

The atomic dispersion of rhodium may comprise rhodium ions and/or rhodium atoms disposed at the location of surface defect sites in the ceria nanoparticle layer.

The colloidal ceria in the catalyst precursor of step (c) may comprise ceria nanoparticles having a D50 diameter of greater than or equal to about 5 nanometers to less than or equal to about 20 nanometers. A weight ratio of the ceria nanoparticles to rhodium in the catalyst precursor may be greater than or equal to about 15:1 to less than or equal to about 100:1.

In a method for removing hydrocarbon, carbon monoxide, and nitrogen oxides from an exhaust gas stream of a gasoline-powered internal combustion engine, the exhaust gas stream may be passed over the layered catalyst.

An exhaust gas treatment device may include the layered catalyst. In such case, the layered catalyst may be deposited on wall surfaces of a monolithic substrate defining a plurality of flow-through passages extending therethrough.

A method of manufacturing a layered catalyst for purifying an exhaust gas stream comprises multiple steps. In step (a), a mixture of colloidal ceria, alumina particles, and a liquid medium are introduced into a drying chamber via an atomizer to form atomized droplets of the mixture. The alumina particles have a D90 particle diameter of greater than or equal to about 5 micrometers to less than or equal to about 9 micrometers. The colloidal ceria comprise ceria nanoparticles having a D50 diameter of greater than or equal to about 5 nanometers to less than or equal to about 20 nanometers. In step (b), a drying gas is introduced into the drying chamber such that the atomized droplets contact the drying gas, the liquid medium is removed from the atomized droplets by evaporation, and the ceria nanoparticles deposit on surfaces of the alumina particles to form composite catalyst support particles having a D90 particle diameter of greater than or equal to about 6 micrometers to less than or equal to about 10 micrometers. The drying gas is introduced into the drying chamber at a temperature of greater than or equal to about 100 degrees Celsius to less than or equal to about 250 degrees Celsius. In step (c), a catalyst precursor comprising a rhodium precursor and colloidal ceria is applied to the composite catalyst support particles. In step (d), the composite catalyst support particles and the catalyst precursor are heated to form the layered catalyst. The layered catalyst comprises an alumina substrate, a ceria nanoparticle layer extending substantially continuously over the alumina substrate, and a rhodium catalyst layer comprising an atomic dispersion of rhodium adsorbed on the ceria nanoparticle layer. The rhodium catalyst layer constitutes, by weight, greater than or equal to about 0.05% to less than or equal to about 0.3% of the layered catalyst.

The composite catalyst support particles may comprise, by weight, greater than or equal to about 1% to less than or equal to about 10% ceria and greater than or equal to about 90% to less than or equal to about 99% alumina. The layered catalyst may comprise, by weight, greater than or equal to about 5% to less than or equal to about 15% ceria and greater than or equal to about 85% to less than or equal to about 95% alumina.

The atomic dispersion of rhodium may comprise rhodium ions and/or rhodium atoms disposed at the location of surface defect sites in the ceria nanoparticle layer.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic depiction of a spray drying apparatus for manufacturing composite catalyst support particles.

FIG. 2 is a schematic cross-sectional view of a composite catalyst support particle comprising an alumina substrate and a ceria nanoparticle layer disposed on the alumina substrate.

FIG. 3 is a scanning electron micrograph of composite catalyst support particles manufactured by the presently disclosed spray drying process, wherein the scale bar represents a length of 30 micrometers.

FIG. 4 is a graph of Cumulative Distribution (%) 100 and Density Distribution (%/μm) 200 vs. Particle Size (μm) 300 for a batch of composite catalyst support particles manufactured by the presently disclosed spray drying process.

FIG. 5 is an enlarged view of a surface portion of the composite catalyst support particle of FIG. 2.

FIG. 6 is a schematic depiction of the composite catalyst support particle of FIG. 5, wherein the ceria nanoparticle layer of the catalyst support particle is impregnated with a catalyst precursor comprising a rhodium precursor and colloidal ceria particles.

FIG. 7 is a schematic depiction of a layered catalyst particle including the composite catalyst support particle of FIG. 5, and a rhodium catalyst layer comprising an atomic dispersion of rhodium adsorbed on the ceria nanoparticle layer of the catalyst support particle.

FIG. 8 is a schematic depiction of an exhaust gas treatment device configured to position a plurality of the layered catalyst particles of FIG. 7 in a path of an exhaust gas stream from a combustion process to help catalyze the conversion of unburned hydrocarbons (HC), carbon monoxide (CO), nitric oxide (NO), and nitrogen dioxide (NO₂) in the exhaust gas stream to carbon dioxide (CO₂), nitrogen (N₂), and water (H₂O) and form a treated gas stream.

In the drawings, reference numbers may be reused to identify similar and/or identical elements.

### DETAILED DESCRIPTION

The present disclosure relates to methods of manufacturing a rhodium (Rh)-, ceria (CeO₂)-, and alumina (Al₂O₃)-containing layered catalyst for purifying exhaust gas streams from combustion processes. During the manufacturing process, composite catalyst support particles are prepared by depositing a thin ceria nanoparticle layer on surfaces of alumina particles using a spray drying technique. The spray drying technique does not result in a substantial increase in the size of the composite catalyst support particles, as compared to that of the alumina particles. The ceria nanoparticle layer provides the composite catalyst support particles with a relatively high defect density, as compared to that of the alumina particles. Then, a rhodium catalyst layer comprising an atomic dispersion of rhodium is formed on the composite catalyst support particles by impregnating the composite catalyst support particles with a rhodium and colloidal ceria-containing catalyst precursor and then calcining the particles. During the impregnation process, rhodium in the catalyst precursor adsorbs on the ceria nanoparticle layer at the location of surface defect sites and the high defect density in the ceria nanoparticle layer is believed to increase the stability of the rhodium in the rhodium catalyst layer. Without intending to be bound by theory, it is believed that the colloidal ceria in the catalyst precursor enhances physical interactions between the rhodium and the composite catalyst support particles during the impregnation process, which helps the rhodium in the rhodium catalyst layer adhere to the composite catalyst support particles.

In practice, the Rh/CeO₂/Al₂O₃ layered catalyst may help catalyze the conversion of unburned hydrocarbons (HC), carbon monoxide (CO), nitric oxide (NO), and nitrogen dioxide (NO₂) in exhaust gas streams from combustion processes to carbon dioxide (CO₂), nitrogen (N₂), and water (H₂O) prior to discharging the exhaust gas streams to the ambient environment. In addition, the Rh/CeO₂/Al₂O₃ layered catalyst may exhibit exceptional aging resistance, with the disclosed Rh/CeO₂/Al₂O₃ layered catalyst exhibiting relatively high catalytic activity even after aging, e.g., after the catalyst structures are subjected to a lean-rich cycling aging protocol.

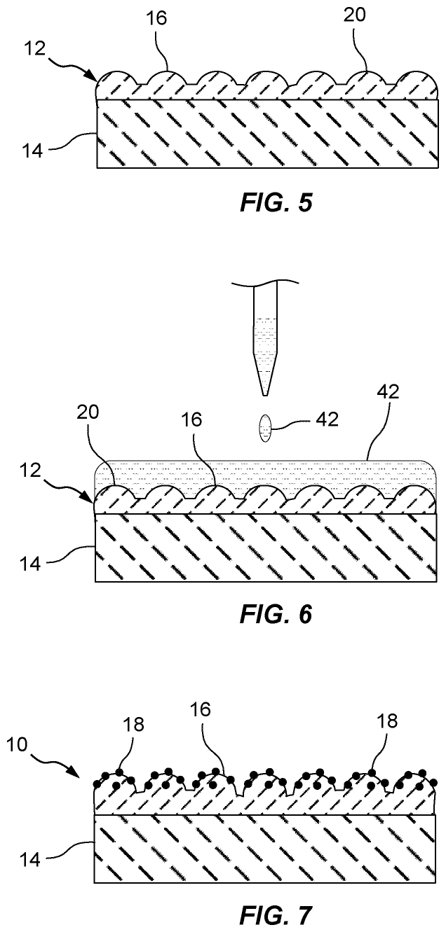

A method of manufacturing layered catalyst particles 10 (FIG. 7) may include a first stage in which composite catalyst support particles 12 (FIGS. 2 and 5) are prepared. Each of the composite catalyst support particles 12 may comprise an alumina substrate 14 and a ceria nanoparticle layer 16. In a second stage, a rhodium catalyst layer 18 (FIG. 7) is deposited on an exterior surface 20 of each of the composite catalyst support particles 12 to form the layered catalyst particles 10.

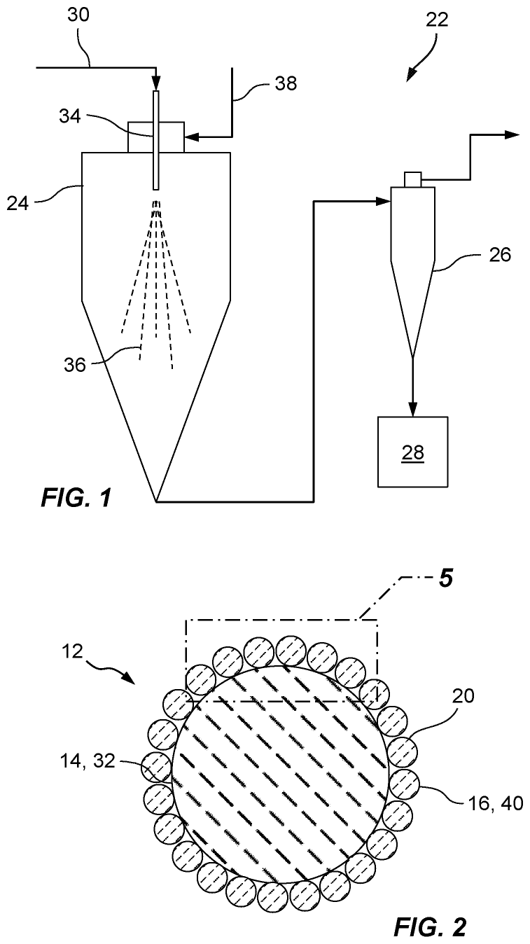

Referring now to FIG. 1, the composite catalyst support particles 12 may be manufactured using a spray drying process, which may include one or more of the following steps. The spray drying process may be performed using a spray drying apparatus 22 comprising a drying chamber 24, a separator 26, and a collector 28. In a first step, a liquid feedstock 30 may be prepared that comprises a mixture of alumina particles 32 (FIG. 2), colloidal ceria, and a liquid medium.

The alumina particles 32 may comprise, consist essentially of, or consist of alumina and may provide the composite catalyst support particles 12 with exceptional thermal and mechanical stability. The alumina particles 32 may have a relatively narrow particle size distribution, which may be achieved by jet milling alumina until a desired average particle size and particle size distribution is achieved. The alumina particles 32 may have a D90 particle diameter of greater than or equal to about 5 micrometers to less than or equal to about 10 micrometers. For example, the alumina particles 32 may have a D90 particle diameter of greater than or equal to about 6 micrometers and less than or equal to about 9 micrometers, or optionally less than or equal to about 8 micrometers. In some aspects, the alumina particles 32 may have a D90 particle diameter of about 7.9 micrometers. The alumina particles 32 may have a D50 particle diameter of greater than or equal to about 2 micrometers and less than or equal to about 4.5 micrometers, optionally less than or equal to about 4 micrometers, or optionally less than or equal to about 3.5 micrometers. In some aspects, the alumina particles 32 may have a D50 particle diameter of about 3.48 micrometers. The alumina particles 32 may have a D10 particle diameter of greater than or equal to about 1 micrometer and less than or equal to about 2 micrometers, optionally less than or equal to about 1.75 micrometers, or optionally less than or equal to about 1.6 micrometers. In some aspects, the alumina particles 32 may have a D10 particle diameter of about 1.52 micrometers. The alumina particles 32 may have a BET surface area of about 80 m²/g and a pore volume of about 0.6 mL/g.

The amount of the alumina particles 32 in the liquid feedstock 30 may be selected to achieve a target alumina loading on the layered catalyst particles 10. For example, the amount of alumina particles 32 in the liquid feedstock 30 may be selected so that the amount of alumina in the layered catalyst particles 10 constitutes, by weight, greater than or equal to about 85% or optionally about 87% to less than or equal to about 95% or optionally about 93% of the layered catalyst particles 10. In aspects, the amount of alumina in the layered catalyst particles 10 may constitute, by weight, about 90% of the layered catalyst particles 10.

The colloidal ceria comprises a plurality of ceria nanoparticles 40 (FIG. 2). The ceria nanoparticles 40 may comprise, consist essentially of, or consist of ceria and may have a D50 diameter of greater than or equal to about 5 nanometers to less than or equal to about 20 nanometers, or greater than or equal to about 10 nanometers to less than or equal to about 15 nanometers. The weight ratio of the alumina particles 32 to the ceria nanoparticles 40 in the liquid feedstock 30 may be selected to achieve a desired weight ratio of alumina to ceria in the composite catalyst support particles 12. For example, the weight ratio of the alumina particles 32 to the ceria nanoparticles 40 in the liquid feedstock 30 may be greater than or equal to about 12.5:1 to less than or equal to about 50:1. In some aspects, the weight ratio of the alumina particles 32 to the ceria nanoparticles 40 in the liquid feedstock 30 may be about 20:1.

The liquid medium used to prepare the liquid feedstock 30 may comprise water (H₂O). The liquid feedstock 30 may be substantially free of a binder, e.g., an organic or inorganic polymer binder. The liquid feedstock 30 may be prepared by stirring the alumina particles 32, the colloidal ceria (including the ceria nanoparticles 40), and the liquid medium together at about ambient temperature (e.g., about 25 °C).

The liquid feedstock 30 may be introduced into the drying chamber 24 via an atomizer 34 to form atomized droplets 36 of the liquid feedstock 30. A drying gas 38 may be introduced into the drying chamber 24. The drying gas 38 may comprise air or an inert gas. The drying gas 38 may be introduced into the drying chamber 24 at a temperature of greater than or equal to about 100 degrees Celsius to less than or equal to about 250 degrees Celsius. For example, the drying gas 38 may be introduced into the drying chamber 24 at a temperature of greater than or equal to about 120 degrees Celsius to less than or equal to about 180 degrees Celsius. When the drying gas 38 is introduced into the drying chamber 24, the atomized droplets 36 may contact the drying gas 38 and the liquid medium may be removed from the atomized droplets 36 by evaporation. At the same time, the ceria nanoparticles 40 may deposit directly on surfaces of the alumina particles 32 (FIG. 2) to form the ceria nanoparticle layer 16 of the composite catalyst support particles 12. The ceria nanoparticle layer 16 may comprise, consist essentially of, or consist of ceria. The ceria nanoparticle layer 16 may have a BET surface area in a range of from about 50 square meters per gram (m²/g) to about 300 m²/g and a pore volume in a range of from about 0.05 milliliters per gram (mL/g) to about 0.3 mL/g.

The composite catalyst support particles 12, the drying gas 38, the evaporated liquid medium, and any other gaseous materials introduced into or produced in the drying chamber 24 during formation of the composite catalyst support particles 12 may be discharged from the drying chamber 24 and introduced into the separator 26, which may comprise a cyclone. In the separator 26, the solid composite catalyst support particles 12 may collect at a lower end of the separator 26 and the gaseous materials may be discharged from the separator 26 at an upper end thereof. The solid composite catalyst support particles 12 may be collected in the collector 28.

As shown in FIG. 2, in each of the composite catalyst support particles 12, the alumina substrate 14 may be defined by one or more of the alumina particles 32 and the ceria nanoparticle layer 16 may be defined by a plurality of the ceria nanoparticles 40. The ceria nanoparticles 40 may deposit on surfaces of the alumina particles 32 at a thickness of greater than or equal to about 50 nanometers to less than or equal to about 200 nanometers or optionally less than or equal to about 100 nanometers. The exterior surface 20 of each of the composite catalyst support particles 12 may be at least partially or entirely defined by the ceria nanoparticles 40. For example, in some aspects, in each of the composite catalyst support particles 12, the ceria nanoparticle layer 16 defined by the ceria nanoparticles 40 may completely encapsulate the alumina substrate 14. The composite catalyst support particles 12 may comprise, by weight, greater than or equal to about 1% or optionally about 3% to less than or equal to about 10% or optionally about 7% ceria and greater than or equal to about 90% or optionally about 93% to less than or equal to about 99% or optionally about 97% alumina. For example, the composite catalyst support particles 12 may comprise, by weight, about 5% ceria and about 95% alumina.

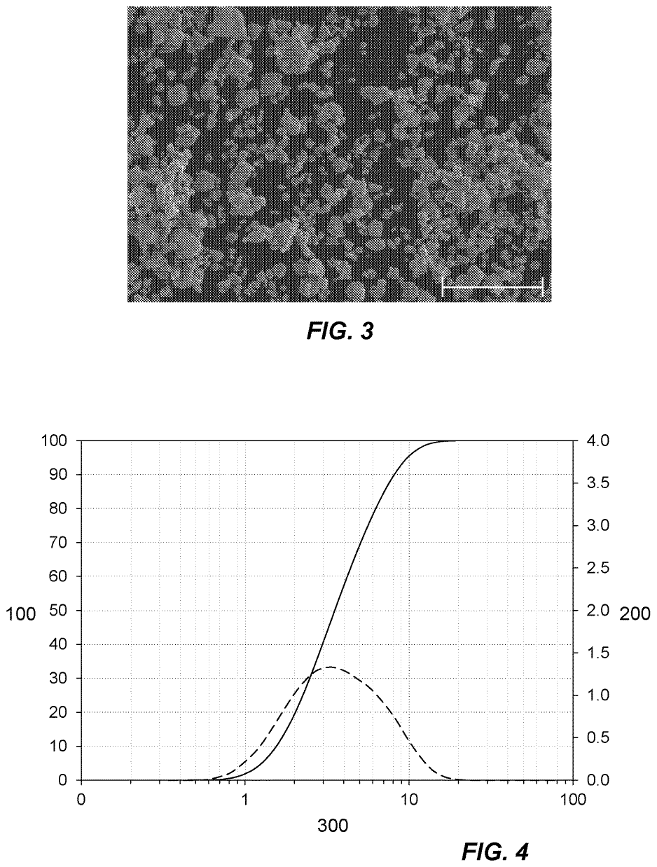

Referring now to FIGS. 3 and 4, the composite catalyst support particles 12 may have a relatively narrow particle size distribution. The composite catalyst support particles 12 may have a D90 particle diameter of greater than or equal to about 6 micrometers or optionally about 7 micrometers to less than or equal to about 10 micrometers, optionally less than or equal to about 9 micrometers, or optionally less than or equal to about 8.5 micrometers. In some aspects, the composite catalyst support particles 12 may have a D90 particle diameter of about 8.1 micrometers. The composite catalyst support particles 12 may have a D50 particle diameter of greater than or equal to about 1.5 micrometers or optionally about 2 micrometers to less than or equal to about 5 micrometers, or optionally about 4 micrometers. In some aspects, the composite catalyst support particles 12 may have a D50 particle diameter of about 3.4 micrometers. The composite catalyst support particles 12 may have a D10 particle diameter of greater than or equal to about 1 micrometers to less than or equal to about 2 micrometers. The particles sizes and particle size distribution of the composite catalyst support particles 12 may be obtained without having to mill, grind, or otherwise treat the composite catalyst support particles 12 after formation thereof.

Referring now to FIGS. 5, 6, and 7, the rhodium catalyst layer 18 may be deposited on the composite catalyst support particles 12 by impregnating the ceria nanoparticle layer 16 of the composite catalyst support particles 12 with a catalyst precursor 42 and then subjecting the composite catalyst support particles 12 and the catalyst precursor 42 to a heat treatment. The ceria nanoparticle layer 16 may be impregnated with the catalyst precursor 42 by applying the catalyst precursor 42 directly to the exterior surface 20 of each of the composite catalyst support particles 12. The catalyst precursor 42 may comprise a mixture of a rhodium precursor, colloidal ceria, and an aqueous medium.

The rhodium precursor may comprise rhodium or a rhodium-containing compound dissolved or dispersed in the aqueous medium of the catalyst precursor 42. Examples of rhodium-containing compounds include rhodium salts, e.g., rhodium(III) nitrate, Rh(NO₃)₃; rhodium(III) chloride, RhCl₃; rhodium(II) acetate, Rh₂(OOCCH₃)₄; and/or rhodium(III) sulfate, Rh₂(SO₄)₃ and rhodium amine complexes, e.g., rhodium(III) pentaamine trinitrate, [Rh(NH₃)₅](NO₃)₃; pentaamminechlororhodium dichloride, [RhCl(NH₃)₅](Cl)₂; rhodium(III) pentaamminechloro sulfate, [RhCl(NH₃)₅]SO₄; and/or pentaammine(nitrito-n)rhodium dinitrate, [Rh(NH₃)₅](NO₂)(NO₃)₂. In aspects, the rhodium compound may be provided in the form of a hydrate complex, e.g., rhodium(III) nitrate dihydrate (Rh(NO₃)₃·(H₂O)ₙ] and/or rhodium(III) chloride hydrate [RhCl₃·(H₂O)ₙ], where n is an integer in the range of 1 to 3. The amount of rhodium in the catalyst precursor 42 may be selected to provide the layered catalyst particles 10 with a target rhodium loading. For example, the amount of rhodium in the catalyst precursor 42 may be selected so that the amount of rhodium in the layered catalyst particles 10 constitutes, by weight, greater than or equal to about 0.05% to less than or equal to about 0.3% of the layered catalyst particles 10. In aspects, the amount of rhodium in the layered catalyst particles 10 may constitute, by weight, about 0.2% of the layered catalyst particles 10.

Like the colloidal ceria in the liquid feedstock 30 used to prepare the composite catalyst support particles 12, the colloidal ceria in the catalyst precursor 42 may comprise a plurality of ceria nanoparticles. Like the ceria nanoparticles in the colloidal ceria in the liquid feedstock 30, the ceria nanoparticles in the colloidal ceria in the catalyst precursor 42 may comprise, consist essentially of, or consist of ceria and may have a D50 diameter of greater than or equal to about 5 nanometers to less than or equal to about 20 nanometers, or greater than or equal to about 10 nanometers to less than or equal to about 15 nanometers. The inclusion of colloidal ceria in the catalyst precursor 42 may help enhance certain desirable physical interactions between the ceria and the rhodium in the layered catalyst particles 10, which may help form a strong bond between the rhodium in the rhodium catalyst layer 18 and the ceria in the ceria nanoparticle layer 16. In addition, the high defect density in the ceria nanoparticle layer 16 is believed to aid in the absorption of a highly stable dispersion of rhodium atoms and/or rhodium ions on the ceria nanoparticle layer 16 at the location of surface defect sites, which may help prevent the formation and/or agglomeration of rhodium particles and/or clusters.

The amount of ceria nanoparticles in the catalyst precursor 42 may be selected to achieve a target ceria loading on the layered catalyst particles 10. For example, the amount of ceria nanoparticles in the catalyst precursor 42 may be selected so that the amount of ceria in the layered catalyst particles 10 constitutes, by weight, greater than or equal to about 5% or optionally about 7% to less than or equal to about 15% or optionally about 13% of the layered catalyst particles 10. In aspects, the amount of ceria in the layered catalyst particles 10 may constitute, by weight, about 10% of the layered catalyst particles 10.

The weight ratio of the ceria nanoparticles to the rhodium in the catalyst precursor 42 may be greater than or equal to about 15:1 to less than or equal to about 100:1 or optionally less than or equal to about 50:1. In some aspects, the weight ratio of the ceria nanoparticles to the rhodium in the catalyst precursor 42 may be about 25:1.

The aqueous medium may comprise water (H₂O). In some aspects, the aqueous medium may comprise an aqueous nitric acid solution (HNO₃) or an aqueous ammonium hydroxide (NH₄OH) solution. The catalyst precursor 42 may be formulated to exhibit a pH of greater than or equal to about 5 to less than or equal to about 12 at a temperature of about 25 °C. In the catalyst precursor 42, rhodium may be present in the form of positively charged Rh³⁺ cations and/or positively charged Rh-containing complexes balanced by anions, e.g., of NO₃⁻, Cl⁻, CH₃COO⁻, and/or SO₄²⁻. Examples of positively charged Rh-containing complexes include [Rh(NH₃)₅]³⁺, [RhCl(NH₃)₅]²⁺, and/or [Rh(NH₃)₆]³⁺. The catalyst precursor 42 may be formulated to promote the adsorption of isolated Rh³⁺ ions on the exterior surface 20 of each of the composite catalyst support particles 12, as explained in U.S. patent application Ser. No. 17/749,894 titled Rhodium-Containing Layered Catalyst Structures and Methods of Making the Same filed May 20, 2022, the contents of which are incorporated herein by reference.

The ceria nanoparticle layer 16 of the composite catalyst support particles 12 may be impregnated with the catalyst precursor 42 using a wet impregnation technique or a dry or incipient wetness impregnation technique. If a wet impregnation technique is used, the volume of the catalyst precursor 42 applied to the composite catalyst support particles 12 will be greater than a calculated pore volume of the composite catalyst support particles 12. If a dry or incipient wetness impregnation technique is used, the volume of the catalyst precursor 42 applied to the composite catalyst support particles 12 may be substantially equal to a calculated pore volume of the ceria nanoparticle layer 16 or of the composite catalyst support particles 12.

After the ceria nanoparticle layer 16 of the composite catalyst support particles 12 is impregnated with the catalyst precursor 42, the composite catalyst support particles 12 and the catalyst precursor 42 may be subjected to a heat treatment to deposit the rhodium catalyst layer 18 on the composite catalyst support particles 12 and form the layered catalyst particles 10. The composite catalyst support particles 12 and the catalyst precursor 42 may be heat treated to remove the aqueous medium, the negatively charged anions, e.g., NO₃⁻, Cl⁻, CH₃COO⁻, and/or SO₄², and reaction byproducts therefrom (e.g., by evaporation), and deposit the rhodium catalyst layer 18 on the ceria nanoparticle layer 16. The heat treatment may include heating the composite catalyst support particles 12 and the catalyst precursor 42 in an oxygen O₂-containing environment (e.g., air) at a temperature of greater than or equal to about 350 °C to less than or equal to about 800 °C for a duration of greater than or equal to about one (1) hour to less than or equal to about 5 hours. In aspects, the heat treatment may comprise heating the composite catalyst support particles 12 and the catalyst precursor 42 in an O₂-containing environment at a temperature of about 500 °C for a duration of about 2 hours to form the rhodium catalyst layer 18 on the ceria nanoparticle layer 16.

During the heat treatment, the ceria nanoparticles in the catalyst precursor 42 may be deposited on and incorporated into the structure of the ceria nanoparticle layer 16. In aspects where rhodium is present in the catalyst precursor 42 in the form of positively charged rhodium-containing complexes, the positively charged rhodium-containing complexes may decompose during the heat treatment. Chemical compounds that may be released in gas or vapor form from the composite catalyst support particles 12 and the catalyst precursor 42 during the third heat treatment may include nitrogen (N₂), nitrogen oxides (e.g., N₂O, NO₂, and/or NO), ammonia (NH₃), and/or H₂O. The rhodium catalyst layer 18 may comprise an atomic dispersion of Rh³⁺ ions, Rh atoms, and optionally a plurality of sub-nanometer sized Rh particles absorbed on the ceria nanoparticle layer 16 at the location of surface defect sites in the ceria nanoparticle layer 16. When present, the sub-nanometer sized Rh particles in the rhodium catalyst layer 18 may have a D50 particle diameter of less than or equal to about one (1) nanometer. The rhodium catalyst layer may be substantially free of Rh particles having diameters greater than or equal to about 1 nanometer and may be substantially free of clusters of Rh particles having diameters greater than or equal to about 1 nanometer.

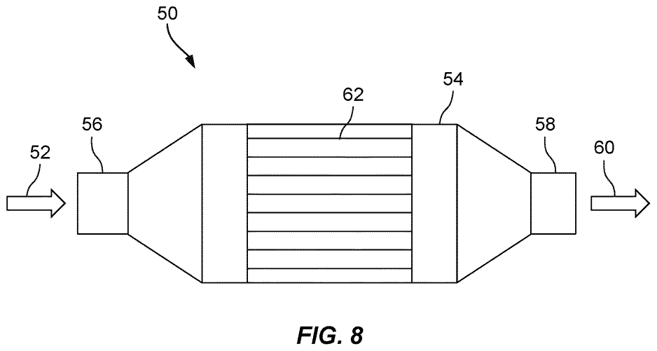

Referring now to FIG. 8, an exhaust gas treatment device 50 may be used to position a plurality of the layered catalyst particles 10 in a path of an exhaust gas stream 52 from a combustion process (not shown) to help catalyze the conversion of unburned hydrocarbons (HC), carbon monoxide (CO), nitric oxide (NO), and nitrogen dioxide (NO₂) in the exhaust gas stream 52 to carbon dioxide (CO₂), nitrogen (N₂), and water (H₂O). In such application, the layered catalyst particles 10 may be referred to as a three-way catalyst. The exhaust gas treatment device 50 may include a housing 54 having an inlet 56 in which the exhaust gas stream 52 is received, an outlet 58 through which a treated gas stream 60 is discharged, and a monolithic substrate 62 supported within the housing 54. The monolithic substrate 62 may include walls having wall surfaces that define a plurality of flow-through passages extending therethrough between the inlet 56 and the outlet 58 of the housing 54. A plurality of the layered catalyst particles 10 may be positioned in the path of the exhaust gas stream 52 by depositing the layered catalyst particles 10 in the form of a slurry or washcoat on the wall surfaces of the monolithic substrate 62 such that, when the exhaust gas stream 52 flows through the flow-through passages in the monolithic substrate 62, the unburned hydrocarbons, carbon monoxide, nitric oxide, and/or nitrogen dioxide in the exhaust gas stream 52 pass in direct contact with the layered catalyst particles 10 deposited on the wall surfaces of the monolithic substrate 62 and are converted to carbon dioxide, nitrogen, and water to form the treated gas stream 60.

The HC, CO, and NO conversion efficiency of the layered catalyst particles 10 may be evaluated by exposing a volume of the layered catalyst particles 10 to a simulated exhaust gas stream including CO, NO, C₃H₆, and C₃H₈. The simulated exhaust gas flow may be heated from an initial temperature of 100 °C to a temperature of 450 °C to determine the HC, CO, and NO conversion efficiency of the layered catalyst particles 10 over a range of temperatures. The term “T50” refers to the temperature at which the layered catalyst particles 10 achieved 50% conversion efficiency. After initial formation of the layered catalyst particles 10, the layered catalyst particles 10 may have a T 50 for CO oxidation of about 230 °C, a T50 for NO reduction of about 268 °C, and a T50 for C₃H₆ oxidation of about 290 °C.

The layered catalyst structure 10 may exhibit exceptionally high catalytic activity, even after the layered catalyst structure 10 is subjected to a simulated gasoline engine exhaust gas stream using a lean-rich cycling aging protocol, wherein the composition of the simulated exhaust gas stream is repeatedly cycled between fuel-lean and fuel-rich simulated engine exhaust conditions. Such lean-rich cycling aging protocols may be performed at temperatures greater than about 950 °C for durations greater than 20 minutes. After the layered catalyst structure 10 is subjected to a lean-rich cycling aging protocol, the layered catalyst structure 10 may have a T50 for CO oxidation of about 315 °C, a T50 for NO reduction of about 370 °C, and a T50 for C₃H₆ oxidation of about 387 °C.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

Any method steps, processes, and operations described herein are not to be construed as necessarily requiring their performance in the order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s), as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges and encompass minor deviations from the given values and embodiments, having about the value mentioned as well as those having exactly the value mentioned. Other than the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%. In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

What is claimed is

1. A layered catalyst comprising:
an alumina substrate;
a ceria nanoparticle layer extending over the alumina substrate; and
a rhodium catalyst layer comprising an atomic dispersion of rhodium adsorbed on the ceria nanoparticle layer.

2. The layered catalyst of claim 1, wherein the rhodium catalyst layer comprises, by weight, greater than or equal to 0.05% and less than or equal to 0.3% of the layered catalyst.

3. The layered catalyst of claim 2, wherein the ceria nanoparticle layer comprises, by weight, greater than or equal to 5% and less than or equal to 15% of the layered catalyst.

4. The layered catalyst of claim 3, wherein the alumina substrate comprises, by weight, greater than or equal to 85% and less than or equal to 95% of the layered catalyst.

5. The layered catalyst of claim 1, wherein the ceria nanoparticle layer comprises ceria nanoparticles having a D50 diameter of greater than or equal to 5 nanometers and less than or equal to 20 nanometers.

6. The layered catalyst of claim 5, wherein the alumina substrate comprises alumina particles having a D90 particle diameter of greater than or equal to 5 micrometers and less than or equal to 9 micrometers.

7. The layered catalyst of claim 6, wherein the ceria nanoparticle layer is deposited on the alumina substrate via a spray drying technique.

8. The layered catalyst of claim 1, wherein a defect density of the ceria nanoparticle layer is greater than a defect density of the alumina substrate.

9. The layered catalyst of claim 8, wherein the atomic dispersion of rhodium comprises rhodium ions and/or rhodium atoms disposed at the location of surface defect sites in the ceria nanoparticle layer.

10. The layered catalyst of claim 1, wherein the rhodium catalyst layer comprises rhodium particles absorbed on the ceria nanoparticle layer at the location of surface defect sites in the ceria nanoparticle layer, and wherein the rhodium particles have a D50 particle diameter of less than or equal to one (1) nanometer.

11. The layered catalyst of claim 10, wherein the rhodium catalyst layer is free of rhodium particles having diameters of greater than 1 nanometer.

12. The layered catalyst of claim 11, wherein the rhodium catalyst layer is free of clusters of rhodium particles having diameters of greater than 1 nanometer.

13. The layered catalyst of claim 1, wherein the layered catalyst is manufactured by:
(a) introducing a mixture of colloidal ceria, alumina particles, and a liquid medium into a drying chamber via an atomizer to form atomized droplets of the mixture;
(b) introducing a drying gas into the drying chamber such that the atomized droplets contact the drying gas, the liquid medium is removed from the atomized droplets by evaporation, and ceria nanoparticles deposit on surfaces of the alumina particles to form composite catalyst support particles;
(c) applying a catalyst precursor comprising a rhodium precursor and colloidal ceria to the composite catalyst support particles; and
(d) heating the composite catalyst support particles and the catalyst precursor to form the layered catalyst.

14. An exhaust gas treatment device, the device comprising:
a monolithic substrate having wall surfaces defining a plurality of flow-through passages extending therethrough; and
a layered catalyst deposited on the wall surfaces of the monolithic substrate, the layered catalyst comprising, by weight:
85% to 95% of an alumina substrate,
5% to 15% of a ceria nanoparticle layer extending over the alumina substrate, and
0.05% to 0.3% of a rhodium catalyst layer comprising an atomic dispersion of rhodium adsorbed on the ceria nanoparticle layer, the atomic dispersion of rhodium including rhodium ions and/or rhodium atoms disposed at the location of surface defect sites in the ceria nanoparticle layer.

15. The device of claim 14, wherein the ceria nanoparticle layer comprises ceria nanoparticles having a D50 diameter of greater than or equal to 5 nanometers and less than or equal to 20 nanometers, the alumina substrate comprises alumina particles having a D90 particle diameter of greater than or equal to 5 micrometers and less than or equal to 9 micrometers, and the ceria nanoparticle layer is deposited on the alumina substrate via a spray drying technique.

16. The device of claim 15, wherein a defect density of the ceria nanoparticle layer is greater than a defect density of the alumina substrate.

17. The device of claim 16, wherein the rhodium catalyst layer comprises rhodium particles absorbed on the ceria nanoparticle layer at the location of surface defect sites in the ceria nanoparticle layer, the rhodium particles have a D50 particle diameter of less than or equal to one (1) nanometer, and the rhodium catalyst layer is free of rhodium particles having diameters of greater than 1 nanometer and is free of clusters of rhodium particles having diameters of greater than 1 nanometer.

18. A method for removing hydrocarbon, carbon monoxide, and nitrogen oxides from an exhaust gas stream of a gasoline-powered internal combustion engine, the method comprising:
passing the exhaust gas stream over a layered catalyst comprising an alumina substrate, a ceria nanoparticle layer extending over the alumina substrate, and a rhodium catalyst layer comprising an atomic dispersion of rhodium adsorbed on the ceria nanoparticle layer, the rhodium catalyst layer comprising, by weight, greater than or equal to 0.05% and less than or equal to 0.3% of the layered catalyst, the alumina substrate comprising, by weight, greater than or equal to 85% and less than or equal to 95% of the layered catalyst, and the ceria nanoparticle layer comprising, by weight, greater than or equal to 5% and less than or equal to 15% of the layered catalyst,
wherein the atomic dispersion of rhodium comprises rhodium ions and/or rhodium atoms disposed at the location of surface defect sites in the ceria nanoparticle layer.

19. The method of claim 18, wherein the exhaust gas stream comprises CO, NO, C₃H₆, and C₃H₈, 50% of the CO in the exhaust gas stream passed over the layered catalyst is oxidized to CO₂ at a temperature of about 230 degrees Celsius, 50% of the NO in the exhaust gas stream passed over the layered catalyst is reduced to N₂ at a temperature of about 268 degrees Celsius, and 50% of the C₃H₆ in the exhaust gas stream passed over the layered catalyst is oxidized to CO₂ and H₂O at a temperature of about 290 degrees Celsius.

20. The method of claim 18, wherein, after the layered catalyst is subjected to a lean-rich cycling aging protocol at a temperature of about 950 degrees Celsius for a duration of greater than 20 minutes, 50% of the CO in the exhaust gas stream passed over the layered catalyst is oxidized to CO₂ at a temperature of about 315 degrees Celsius, 50% of the NO in the exhaust gas stream passed over the layered catalyst is reduced to N₂ at a temperature of about 370 degrees Celsius, and 50% of the C₃H₆ in the exhaust gas stream passed over the layered catalyst is oxidized to CO₂ and H₂O at a temperature of about 387 degrees Celsius.
